(19) United States
(12) Patent Application Publication
(10) Pub. No.: US 2013/0159126 A1
(43) Pub. Date: Jun. 20, 2013

(54) WITH-ME SOCIAL INTERACTIVITY PLATFORM

(71) Applicant: Amr Elkady, Walnut Creek, CA (US)

(72) Inventor: Amr Elkady, Walnut Creek, CA (US)

(21) Appl. No.: 13/717,682

(22) Filed: Dec. 17, 2012

Related U.S. Application Data
(60) Provisional application No. 61/576,802, filed on Dec. 16, 2011.
(60) Provisional application No. 61/682,142, filed on Aug. 10, 2012.

(51) Int. Cl. H04L 29/06; G06Q 50/00

(52) U.S. Cl. CPC H04L 65/60; H04L 51/32; G06Q 30/0601; G06Q 50/01
USPC 705/26.1; 709/219; 709/204

(57) ABSTRACT

A method is disclosed for enabling a coordinated event among a plurality of user locations, in which each user location is located geographically separate from all other user locations. The coordinated event comprises a substantially synchronous rendering of a predetermined and common digital media stream at each user location. In one embodiment, the method requires that each user location identify its own personal independent source of the common digital media stream. The method then causes each user location's personal independent source of the common digital media stream to render the common digital media stream at the corresponding user location. The method then synchronizes the renderings of the common digital media stream at each user location regardless of and agnostic to each user location's personal independent source thereof.

### CROSS-REFERENCE TO RELATED APPLICATIONS

This application claims the benefit of, and priority to, both of the following two (2) commonly-invented U.S. Provisional Applications: (1) Ser. No. 61/576,802, filed Dec. 16, 2011 (hereafter, the “First Provisional Application”); and (2) Ser. No. 61/682,142, filed Aug. 10, 2012 (hereafter, the “Second Provisional Application”).

### FIELD OF INVENTION

This disclosure describes inventive material in the networked data communication field.

### BACKGROUND OF THE INVENTION

The First Provisional Application discloses “Personal Cloud” technology in FIGURES A and B thereof and accompanying and related disclosure (primarily in, but not limited to, paragraphs 0038 through 0048). All such “Personal Cloud” disclosure in the First Provisional Application is incorporated herein by reference. The disclosure of the Second Provisional Application is incorporated herein by reference in its entirety.

An often-heard comment in our high-tech society today is that, despite all of the technology, people do not do as much together as they used to before all the technology was available. That is, even though the technology can often facilitate doing things together in a social environment, it often serves to isolate us. There is therefore a need in the art for technology that encourages people to be more “social” together again, i.e. to “do things” together.

The principle of shared, synchronous viewing in multiple distributed locations is known in the art. See, for example, published U.S. Patent Application 2009/0044216 (inventor McNicoll) and published U.S. Patent Applications 2010/0306655 and 2010/0306671 (assignee Microsoft). However, the shared viewing experience as disclosed in the prior art (including as disclosed in the foregoing published applications) suffers from a number of disadvantages.

For example, the prior art typically discloses multiple distributed viewing locations using media obtained from a single source. The media is copied and rebroadcast to the multiple viewing locations. This presents a number of issues, including technical and copyright issues.

By way of further example, the prior art typically discloses nominating a “master user” (or analogous nomenclature) whom the system designates as having sole control over the viewing experience (e.g. pause, rewind, etc.) Although master user privileges may be transferred from one viewing location to another, the paradigm of “master user” remains This may diminish the viewing experience of those users who are participating and who have no control over the media they may be watching.

By way of yet further example, the prior art typically discloses considerable effort to playback (or “render”) the media as synchronously as possible at multiple distributed viewing locations. This goal of “highest achievable synchronicity” is seen as a flaw in prior art approaches. Real time corrections in synchronicity will inevitably cause individual playback experiences at the various locations to “stutter”, or jump, or rewind, or pause. In reality, however, a group of users enjoying shared viewing in one location will likely never notice if playback is not exactly “in synch” with corresponding playback in other locations. Even if noticed, such users are unlikely to be troubled by the lack of exact synchronicity, especially if this means that their own playback experience is more likely to be free of synchronicity corrections.

Another example of a prior art disadvantage is that the prior art typically fails to recognize the processing efficiencies available when “session control” (i.e. high-level control over the overall shared viewing experience, such as credential authentication of applicants to join the shared viewing group, monitoring and announcement of current viewing group members) is separated from “message control” (i.e. lower-level control over interaction between viewing group members, such as playback control commands, “chat” messaging and other viewing group interactivity). Session control tends to comprise limited (and occasionally one-time) tasks, while message control tends to comprise more frequent, repetitive tasks, requiring capacity for higher processing traffic. The prior art, however, typically uses common processing architecture for both session control and message control.

### SUMMARY OF THE INVENTION

Disadvantages in the prior art, including the above-described disadvantages, are addressed by the “With-Me” inventive technology disclosed in this application.

First, however, for purposes of this application, “User Location” as used herein refers to a discrete geographic location where one or more users may be physically gathered together at a single media rendering device (such as a television or a computer screen). As will be more fully appreciated further on, a feature of With-Me is that it connects media devices located in physically separate geographic locations (i.e. at the User Locations, as that term is used herein). So, for the avoidance of doubt, the concept of a User Location, as the term is used in this disclosure, is agnostic to whether there may be more than one person gathered together at a media rendering device at a User Location.

With-Me is a social interactivity platform that builds on the Personal Cloud technology disclosed in the First Provisional Application. With-Me allows users to enjoy a media-rendering experience together (such as, for example, watching a movie together) as if they are all physically present together, even though they may be in geographically different locations (User Locations). To enable this “shared experience”, preferred embodiments of the With-Me platform separate the media-rendering controls from the delivery of the commercial media itself within a group connection of User Locations over a cloud or network. As such, in preferred embodiments, each User Location will likely require different credentials to access the With-Me platform and to access that User Location's own personal source of the commercial media. With-Me may first assist any User Location with gaining access (e.g. logging on) to that User Location's source of the commercial media, or alternatively the User Location may gain such access directly by itself. With-Me then synchronizes the delivery of the same content to each User Location via coordinated control over each User Location's media rendering device. With-Me directs each User Location's media device to deliver the content to the User Location from its own authorized source. With-Me then allows shared control over the coordinated content among all the User Locations. Thus any user at any User Location may stop or pause the content (just for example), and all other User Locations will experience the result, even though the content is being delivered to each User Location from its own accredited source.

It is important to clarify that in preferred embodiments, the With-Me platform does not re-broadcast the content from one User Location to others. Each User Location must have its own proper access and legal accreditation to its own independent source of the coordinated content (e.g. online stream from a source such as NetFlix® or Hulu®, or offline content from a source such as a DVD). Each User Location must obtain its own coordinated content from any legal source (or type of source) that may be available to that User Location. Regardless of the source (or type of source) of the coordinated content at each User Location, With-Me coordinates the playback (and other user-enabled media controls) among User Locations so that the media experience is identical and synchronized at each User Location. In this way, participants at each User Location are given the experience of watching (or experiencing) the content “together”, simulating “shared” content, even though the content is in fact obtained at each User Location according to that User Location's own separate accredited source of the content.

It is further important to clarify that in preferred embodiments, synchronous delivery of the content to each User Location is via “fuzzy” or “lazy” synchronicity, meaning that With-Me is not concerned whether content is delivered to each User Location in exact synchronicity. As noted above, a group of users enjoying shared viewing in one User Location will likely never notice if playback is not exactly “in synch” with corresponding playback in other User Locations. Even if noticed, such users are unlikely to be troubled by the lack of exact synchronicity, especially if this means that their own playback experience is more likely to be free of synchronicity corrections such as “stutters”, jumps, rewinds or pauses.

It is further important to clarify that in preferred embodiments, the With-Me platform separates session control from message control (as those terms were discussed in the “Background” section above). In such embodiments, the processing of the With-Me platform may be more efficient.

It is therefore a technical advantage of With-Me to allow a group of users, although in physically separate locations, to interact with one another while doing something together. In preferred embodiments, the “doing something” is content-provider-agnostic. In other words, preferred embodiments of With-Me function regardless of who or what provides the coordinated content (i.e. the source of the content), or what the subject matter or the format of the content may be. Examples (without limitation) of coordinated content may include streaming content, such as a previously-broadcast TV show from Hulu®, or a movie from NetFlix®, or a video game from a commercial provider, or content from YouTube®, or content from a cloud drive. Other examples (without limitation) may include content from a portable storage device like a CD, DVD, mp3 player, USB drive, and so on. As noted, With-Me is not limited to any particular content source and is capable of mix-and-match of content sources for the same session.

A further technical advantage of With-Me is that in accordance with preferred embodiments, concerns regarding copyright and other digital media rights can be easily addressed. As noted, each User Location in a prospective coordinated-content event requires its own connection and valid credentials (such as a subscription or an account) to the chosen coordinated content, even if the source of the content (e.g. Hulu® or NetFlix®) is the same for two or more User Locations. In such cases of a common content source amongst User Locations, each User Location will require its own separately-accredited subscription or account to the content source. With-Me will then cause each User Location's media player to play the coordinated content obtained from its own media source, synchronously with all the other User Locations, subject to shared control of the synchronized playback among the User Locations via the With-Me platform. Since there is no re-broadcast of content involved, With-Me thus encourages a copyright-compliant coordinated event. In another embodiment, With-Me may have an agreement with a third party content provider to deliver the content to each User Location in a controlled, copyright-compliant manner (analogous to the way in which a service such as NetFlix® offers content to subscribers). Again, each User Location must have its own separate accreditation, but in this last exemplary embodiment, the With-Me platform is the media source acting as a reseller and/or a distributor of third party content. In this way, With-Me may potentially generate a revenue stream.

A further technical advantage of With-Me is that in accordance again with preferred embodiments, With-Me saves bandwidth over a conventional coordinated-content event where re-broadcasting may be required. As noted, only the media controls are actually “shared” among the User Locations, and the group relaying of such control commands will require comparatively little bandwidth.

A further technical advantage of With-Me is that by collaborating with certain embodiments of With-Me, third party online content providers (such as NetFlix, Hulu®) can enrich the value of their individual User Location subscriptions by offering the opportunity to experience their media content in a coordinated group event. Subscribers could pay extra for access to this feature.

A further technical advantage of With-Me is that in preferred embodiments, content delivery at User Locations is less likely to be interrupted by unexpected “stutters”, jumps, rewinds or pauses (caused by synchronicity corrections with other User Locations), even though content delivery at that User Location may not be in exact synchronicity with other User Locations.

A further technical advantage of With-Me is that in preferred embodiments, the With-Me platform separates session control from message control (as those terms were discussed in the “Background” section above). In such embodiments, the processing of the With-Me platform may be more efficient.

The foregoing has outlined rather broadly the features and technical advantages of the inventive technology disclosed in this application in order that the detailed description that follows may be better understood. Additional features and advantages may be described hereinafter, all of which together form the subject of the claims set forth further below. It should be appreciated by those skilled in the art that the conception and the specific embodiments disclosed may be readily utilized as a basis for modifying or designing other structures for carrying out the same purposes. It should be also be realized by those skilled in the art that such equivalent constructions do not depart from the spirit and scope of the inventive technology disclosed in this application as further set forth in the appended claims.

### BRIEF DESCRIPTION OF THE DRAWINGS

For a more complete understanding of the inventive technology disclosed in this application, and the advantages thereof, reference is now made to the following detailed description taken in conjunction with the accompanying drawings, in which:

FIG. 1 illustrates one exemplary embodiment of the With-Me platform enabling a coordinated content event, where the coordinated content is digital streaming media provided to each User Location by a single third party;

FIG. 2 illustrates another exemplary embodiment of the With-Me platform enabling a coordinated content event, where the coordinated content is the same digital streaming media provided to each User Location by different third parties;

FIG. 3 illustrates a further exemplary embodiment of the With-Me platform enabling a coordinated content event, where the coordinated content is provided by offline media (a DVD) at two User Locations, and by digital streaming media at a third User Location;

FIG. 4 illustrates a further exemplary embodiment of the With-Me platform acting as a reseller and/or distributor of shared online third party content to User Locations;

FIG. 5 illustrates embodiments of the With-Me platform at a high functional level;

FIG. 6 illustrates aspects of With-Me functionality in flow chart form;

FIG. 7 illustrates an exemplary embodiment of the With-Me platform with centralized message control;

FIG. 8 illustrates, in contrast to FIG. 7, an alternative exemplary embodiment of the With-Me platform with distributed message control;

FIG. 9 illustrates, in flow chart form, an exemplary “virtual living room” style implementation of the With-Me platform; and

FIG. 10 illustrates, in contrast to FIG. 9, and also in flow chart form, an exemplary “virtual cinema” implementation of the With-Me platform.

### DETAILED DESCRIPTION

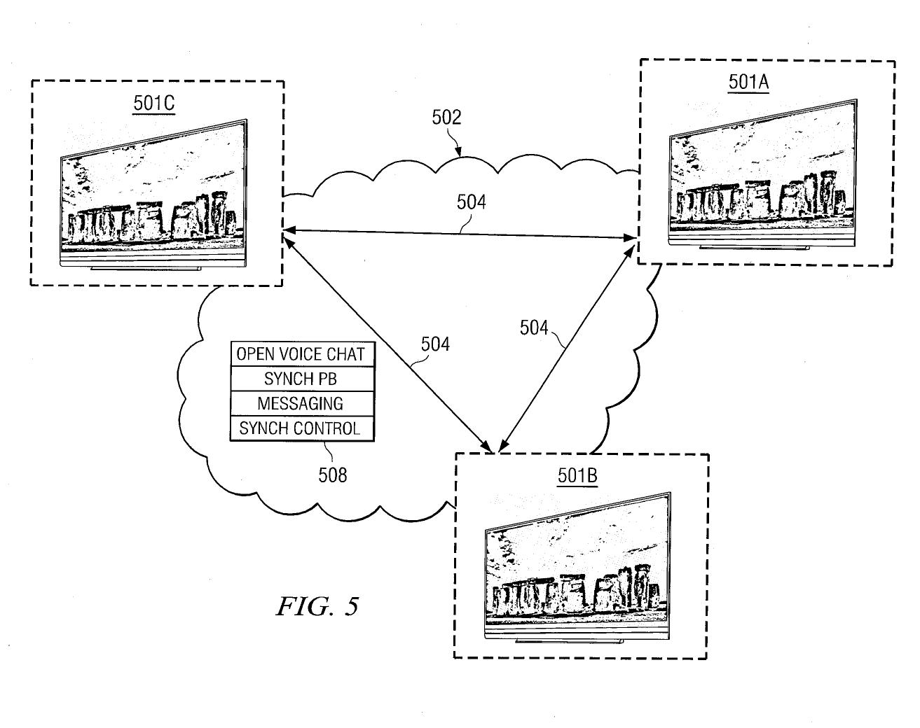

Referring first to FIG. 5, the With-Me platform is illustrated functionally at a high level. A plurality of User Locations 501A, 501B and 501C are operatively connected via data communication over network/cloud 502. FIG. 5 illustrates an exemplary number of three User Locations. With-Me is not limited, however, to any particular number of User Locations in a plurality thereof. Although not called out by individual part number, it will be understood from review of FIG. 5 that User Locations 501A, 501B and 501C each comprise media playback devices (or more generically, “media rendering devices”) illustrated on FIG. 5 as televisions. In other embodiments, such media rendering devices could be, for example, computer screens, smart phones, tablet computers or movie projection screens. With-Me is not limited to any particular media rendering device at any User Location.

FIG. 5 further illustrates that User Locations 501A, 501B and 501C exchange media control commands via pathways 504. It will be further understood that in accordance with earlier disclosure, With-Me separates such media control command structure from its corresponding structure that synchronizes delivery of the media content itself to each of User Locations 501A, 501B and 501C. Box 508 on FIG. 5 illustrates examples of separate high-level functions enabled by With-Me, such as Open Voice Chat, Synchronized Playback, Messaging (between User Locations during playback, similar to texts or IM), and Synchronized Control. In this way, box 508 further illustrates separation of the media control command structure from corresponding synchronized media delivery (playback) structure. It will be further understood that although not illustrated on FIG. 5, box 508 (and associated exemplary With-Me high-level functions) are not limited to being deployed on the same network or cloud. Architecture enabling these functions may include separate networks, servers and/or IP addresses, for example. The inventive technology disclosed in this application is not limited in this regard.

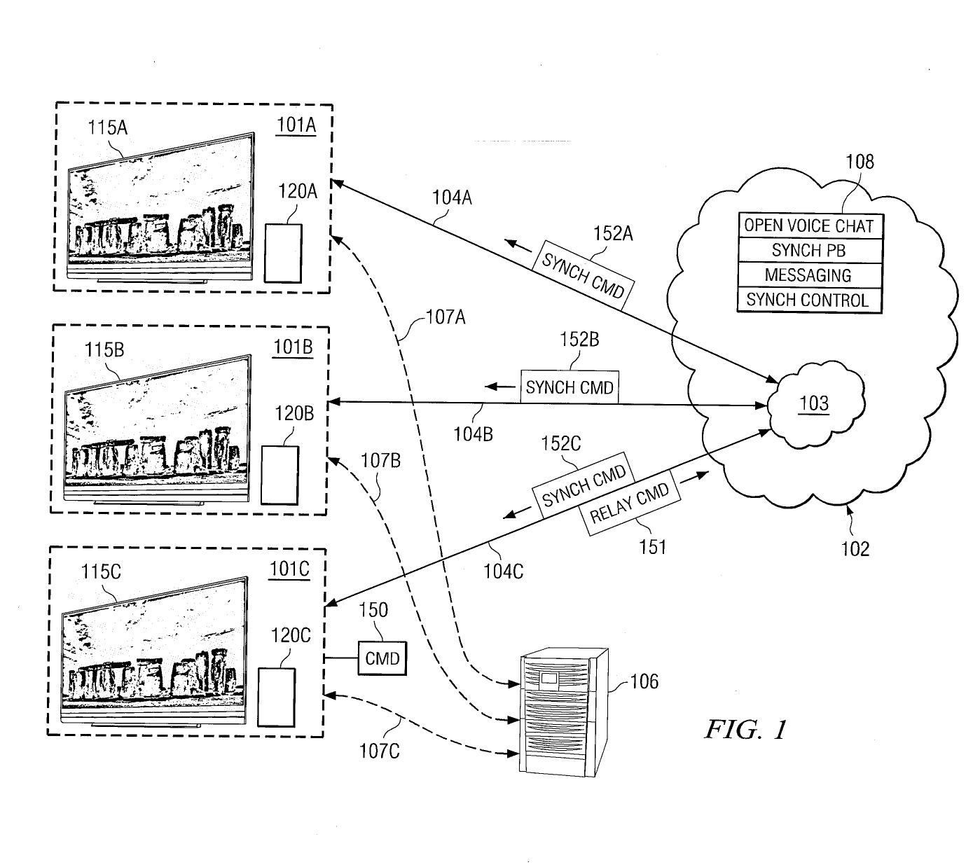

Turning now to FIGS. 1, 2, 3 and 4, these illustrations should be viewed together, and illustrate alternative embodiments of the inventive technology disclosed in this applications. Parts and components on FIGS. 1, 2, 3, and 4 are assigned numbers in the corresponding 100, 200, 300 and 400 series. However, common parts or components illustrated in the various embodiments of FIGS. 1, 2, 3 and 4 are assigned corresponding numbers within the series.

FIG. 1 illustrates a first embodiment of the With-Me platform. User Locations 101A, 101B and 101C each represent a physically or geographically separated User Location in a plurality thereof. By way of example only, there are three (3) User Locations illustrated in the plurality thereof on FIG. 1. Consistent with FIG. 5, User Locations 101A, 101B and 101C as shown on FIG. 1 each comprise a media rendering device 115A, 115B and 115C. In the exemplary embodiment of FIG. 1, media rendering devices 115A, 115B and 115C are televisions, although in other embodiments such media rendering devices could be, for example, computer screens, smart phones, tablet computers or movie projection screens. The inventive technology disclosed herein is not limited in this regard. User Locations 101A, 101B and 101C as shown on FIG. 1 each further comprise a media playback device 120A, 120B and 120C. Media playback devices 120A, 120B and 120C are characterized to use media rendering devices 115A, 115B and 115C to play back media content delivered to corresponding User Locations 101A, 101B and 101C by a common digital streaming content provider 106, subject to control by the With-Me platform.

Functional connectors and pathways 107A, 107B and 107C on FIG. 1 illustrate that each of User Locations 101A, 101B and 101C has its own, separately accredited subscription and/or account with a common digital streaming content provider 106 that will, for illustrative purposes on FIG. 1, be providing synchronized content to each of User Locations 101A, 101B and 101C in a group event. In the embodiment illustrated on FIG. 1, the common content provider 106 may, for example, be NetFlix®. In the group event, participants at each of User Locations 101A, 101B and 101C are going to watch the same movie together, even though each of User Locations 101A, 101B and 101C sources the streaming movie content from NetFlix® independently, via separate authorized accounts, along corresponding pathways 107A, 107B and 107C.

It will be appreciated that in the embodiment of FIG. 1, the With-Me platform is content agnostic. Although the FIG. 1 example illustrates watching a NetFlix® movie as a coordinated content event, it will be appreciated that consistent with FIG. 1, the coordinated content could be any offering of common streaming content to which each of User Locations 101A, 101B and 101C have separate, independent authorized access. The subject matter of the content could be music, games or any other digital media suitable for streaming.

In FIG. 1, With-Me advantageously coordinates each User Location's access to the movie prior to beginning the group event. With-Me enables such coordination via network/cloud 102 (as shown on FIG. 1) either automatically, or alternatively responsive to a manual login by a User Location. Consistent with FIG. 5 and associated disclosure above, network/cloud 102 on FIG. 1 further enables multiple exemplary With-Me functions for each of User Locations 101A, 101B and 101C, including Open Voice Chat, Synchronized Playback, Messaging between User Locations during playback, and Synchronized Control (see box 108 on FIG. 1). As such, FIG. 1 illustrates that consistent with FIG. 5 and other earlier disclosure, With-Me has, in preferred embodiments, completely separate structure: (1) controlling synchronization of the delivery of the media content to User Locations 101A, 101B and 101C, and (2) enabling control over the playback of the media by User Locations 101A, 101B and 101C.

The structure enabling control over the playback of the media by User Locations 101A, 101B and 101C is illustrated on FIG. 1 by sub-portion 103 of the With-Me network/cloud 102. Each of User Locations 101A, 101B and 101C are operatively connected to sub-portion 103 via pathways 104A, 104B and 104C. User Location 104C issues a playback command 150. The playback command may be any command, such as stop, pause, rewind, etc. The playback command is relayed from User Location 101C to sub-portion 103 of network/cloud 102 (see box 151 on FIG. 1), and is then synchronously echoed back to all User Locations 101A, 101B and 101C (see boxes 152A, 152B and 152C on FIG. 1). Upon receipt of the echoed-back commands 152A, 152B and 152C, each of the media playback devices 120A, 120B and 120C at User Locations 101A, 101B and 101C execute the command substantially simultaneously.

It will be appreciated that although FIG. 1 illustrates the example of User Location 101C as having issued playback command 150, the inventive technology disclosed in this application is not limited in this regard. Any of User Locations 101A, 101B or 101C could have issued the command at any time. Under the With-Me platform, there is, as noted above, no “Master User Location” that may be functionally “holding the only remote control”. Consistent with the above disclosure, any User Location may issue any playback command at any time, and all such commands will be relayed and echoed back to all User Locations as they arise. In this way, under the With-Me platform, all User Locations have full shared control over playback of the media during the group event.

Further, it will be appreciated that although FIG. 1 illustrates User Location 101C has having issued an example of a playback command, the inventive technology disclosed in this application is not limited in this regard. The With-Me platform may also circulate other types of messages or commands among User Locations via the relay/echo back structure illustrated on FIG. 1 and described above. Such types of messages or commands may include, without limitation, voice comments, or text messages, or video conferencing, or “like” or “dislike” flags, etc. The With-Me platform is not limited to any mode or modes of interactivity between User Locations in a group event.

With continuing reference to FIG. 1, there now follows a description of an exemplary coordinated group event in accordance with the embodiment of FIG. 1. It will be understood that the following description is exemplary only, for illustrative purposes, and that, consistent with the breadth of the disclosure in this application, many other variants of the group event are within the scope of the inventive technology disclosed herein.

According to FIG. 1, User Locations 101A, 101B and 101C decide to hold a coordinated group event. User Locations separately and independently log in to the With-Me platform and identify to With-Me the media content whose playback will be the coordinated event, and, for each User Location, that User Location's own authorized and legal source of the content. On FIG. 1, just for example, the source of the content is a digital streaming service such as NetFlix®, and each User Location has its own separate subscription to the service (see item 106 on FIG. 1 and pathways 107A, 107B and 107C). The With-Me platform checks each User Location's access credentials and then, via access to each User Location's media player 120A, 120B and 120C, cues up the content (sourced from the digital streaming service) on each User Location's media player 115A, 115B and 115C.

With further reference to FIG. 1, once the content is cued up, the With-Me platform synchronizes playback thereof at each User Location, even though each User Location's source of the content is a separate digital streaming service subscription. Note that any User Location may start the content playback at any time, at which time synchronized playback will begin at all other User Locations. While the content is playing, the With-Me platform on FIG. 1 then coordinates the control of the delivered content among all User Locations even though the content is being delivered separately (although synchronously) to each User Location direct from the digital streaming service 106.

The With-Me platform's separate coordination of control of the content is further illustrated by example on FIG. 1. As noted immediately above, any User Location may start the content playback at any time, at which time synchronized playback will begin at all other User Locations. Alternatively, perhaps communicating over the With-Me platform via, for example, open voice chat or messaging, the group of User Locations 101A, 101B or 101C may decide that a designated User Location (say, for example, User Location 101C) will start the playback at an agreed-upon time. Either way, once a User Location issues a “play” command, the With-Me platform then coordinates synchronous playback with the media players of all User Locations, even though the content is being delivered to User Locations' media players directly from the digital streaming service. The group is now watching the content “together” in a virtual sense, and may interact via the With-Me platform's voice chat and messaging features while playback continues, as if the group was “together” in a physical sense.

According to the embodiment of the With-Me platform illustrated on FIG. 1, once the coordinated event has started, any User Location may interact to command the playback of the content, using commands such as, for example: stop, pause, freeze, rewind, fast-forward, slow down, speed up, re-start or replay, etc. The With-Me platform relays these commands to all User Locations in the group event, so that the content delivery continues to be a coordinated and synchronized event. Note that the foregoing control commands are exemplary only, and that the With-Me platform relays any control command from one User Location to all of the other User Locations in the group.

With peripheral reference to FIG. 1, there now follows a discussion of preferred embodiments of the “lazy” (or “fuzzy”) mode in which the With-Me platform synchronizes the delivery of content to each User Location. As noted earlier in this disclosure, the prior art appears to expend considerable effort attempting to deliver content to each group event participant as synchronously as possible. As described in more detail above, this goal of “highest achievable synchronicity” subjects group event participants to potential “resynchronizing” interruptions during playback, such as playback “stutter”, or even pause or rewind. The “resynchronizing” structure also potentially consumes processing power and data communication bandwidth.

In contrast, preferred embodiments of the With-Me platform implement “lazy” (or “fuzzy”) synchronization, in which playback at User Locations may not be perfectly synchronous. In fact, they are all likely to be somewhat out of perfect synchronicity, by even as much as about 2 seconds across all User Locations. As noted above, this asynchronicity is likely not to be noticed by participants at User Locations. Even if noticed, such asynchronicity is likely to be tolerated by participants at User Locations, especially when the alternative might involve (apparent) arbitrary playback interruptions to effectuate resynchronizations.

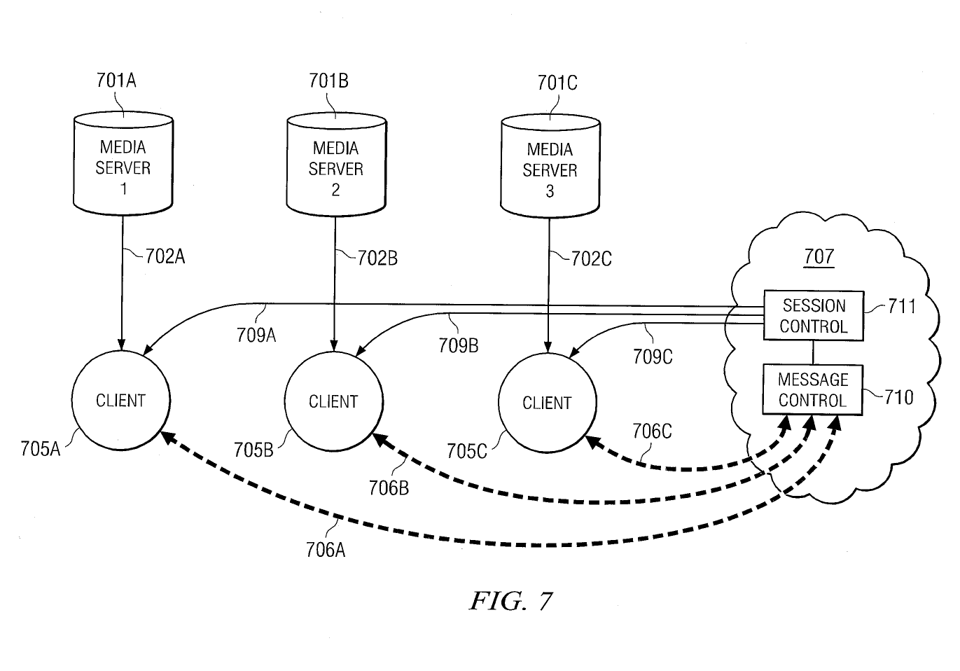

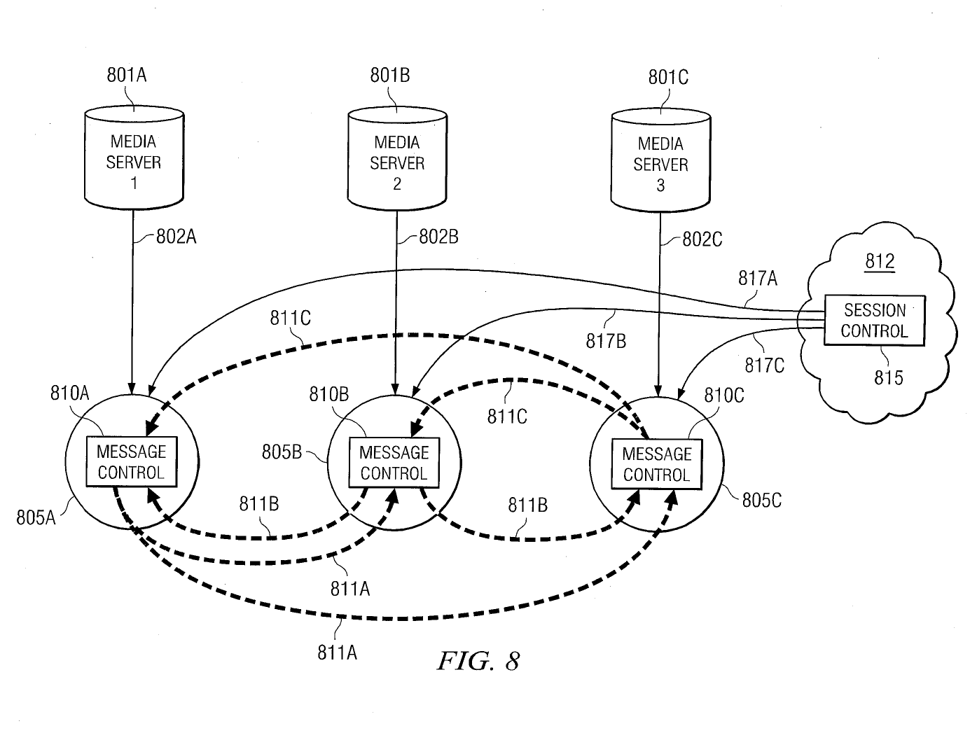

Preferred embodiments of the With-Me platform implement “lazy” synchronicity by simply not implementing structure that ensures near-exact synchronicity. It should be noted that the With-Me platform structure that synchronizes delivery of the content at each User Location is a separate structure from session control structure and message control structure (see below for discussion in association with FIGS. 7 and 8). This separate synchronization structure may be deployed on a different network or server than other With-Me functions. In optimizing synchronous delivery of content, and while avoiding structure to monitor and correct for ongoing near-exact synchronicity, the synchronization structure of the With-Me platform employs small-sized control packets (in order to promote faster routing and processing) and creates a lightweight, fast-response broadcast controller. Further optimization may be enhanced in embodiments in which each User Location is directly connected to all other User Locations via a mesh connection (i.e. listening on a given network port and accepting commands form a list of authorized originating addresses).

Preferred embodiments of the “lazy” synchronization aspect of the With-Me platform may further implement a “re-synchronize” command available to all User Location via shared playback control. In such embodiments, when any User Location believes that re-synchronization may be optimal, that User Location may issue the “re-synchronize” command, whereupon the With-Me platform will conduct a one-time re-synchronization at all User Locations Further, optionally, With-Me may make a one-time re-synchronization automatically when it perceives that playback at User Locations has become out of synchronization with playback at other User Locations beyond a pre-determined acceptable time lag (say, for example only, about 2 seconds).

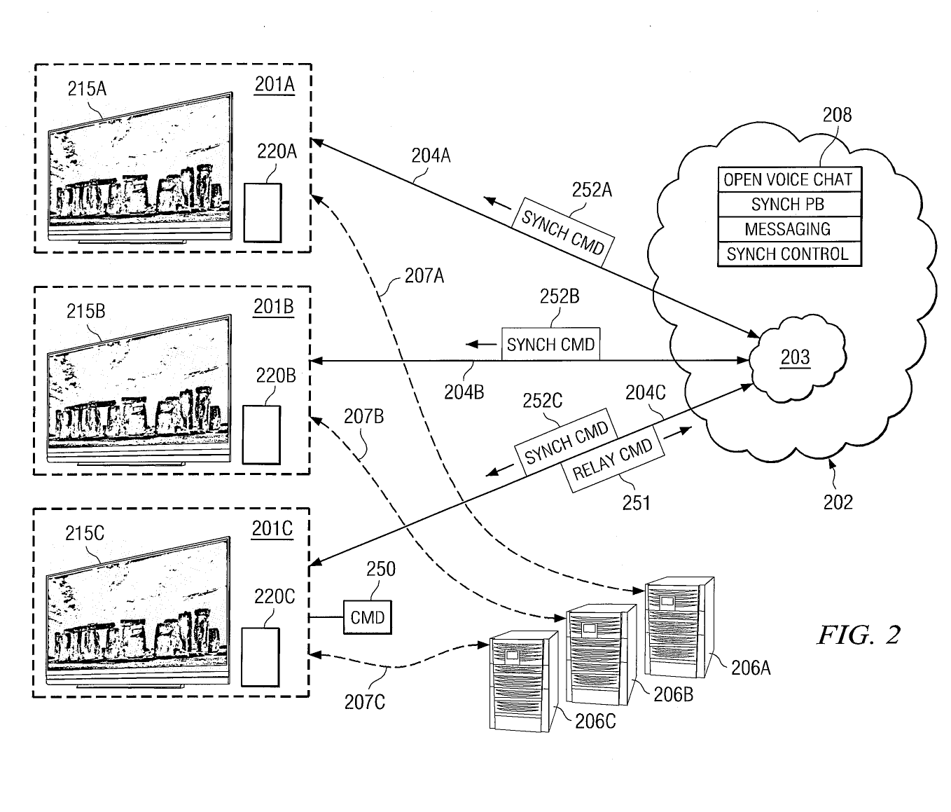

FIG. 2 illustrates the same coordinated group event of FIG. 1, except that in FIG. 2, the digital streaming service provider of the coordinated content is not the same for each User Location. As noted above, although parts and components on FIG. 2 are assigned numbers in the 200 series, common parts or components illustrated in the various embodiments of FIGS. 1, 2, 3 and 4 are assigned corresponding numbers within each FIGURE's series of numbers. In FIG. 2, participants in the group of User Locations 201A, 201B and 201C are going to watch the same digital streaming content together (such as a movie), just as they were in FIG. 1. In FIG. 2, however, each User Location sources the coordinated digital streaming media (i.e., the same movie) from a different digital streaming media service. On FIG. 2, purely by way of example, User Location 201A may be using its own authorized account with Hulu® to source the content, User Location 201B may be using its own authorized account with HBO® to source the same content offered by HBO®, and User Location 201C may be using its own authorized account with NetFlix® to source the same content offered by NetFlix®. These separate digital streaming service providers are illustrated on FIG. 2 as 206A, 206B and 206C, operatively connected to User Locations 201A, 201B and 201C by pathways 207A, 207B and 207C respectively. Even though the same digital streaming content is being delivered to each User Location on FIG. 2 from three different and separate sources, the With-Me Platform nonetheless (just as in FIG. 1 and associated disclosure) synchronizes the playback at each User Location and coordinates shared control over playback of the content among all User Locations. It will be appreciated that all disclosure above associated with FIG. 1 regarding shared control (including playback commands, messaging and User Location interactivity during playback) also applies with equivalent effect to the embodiment of FIG. 2.

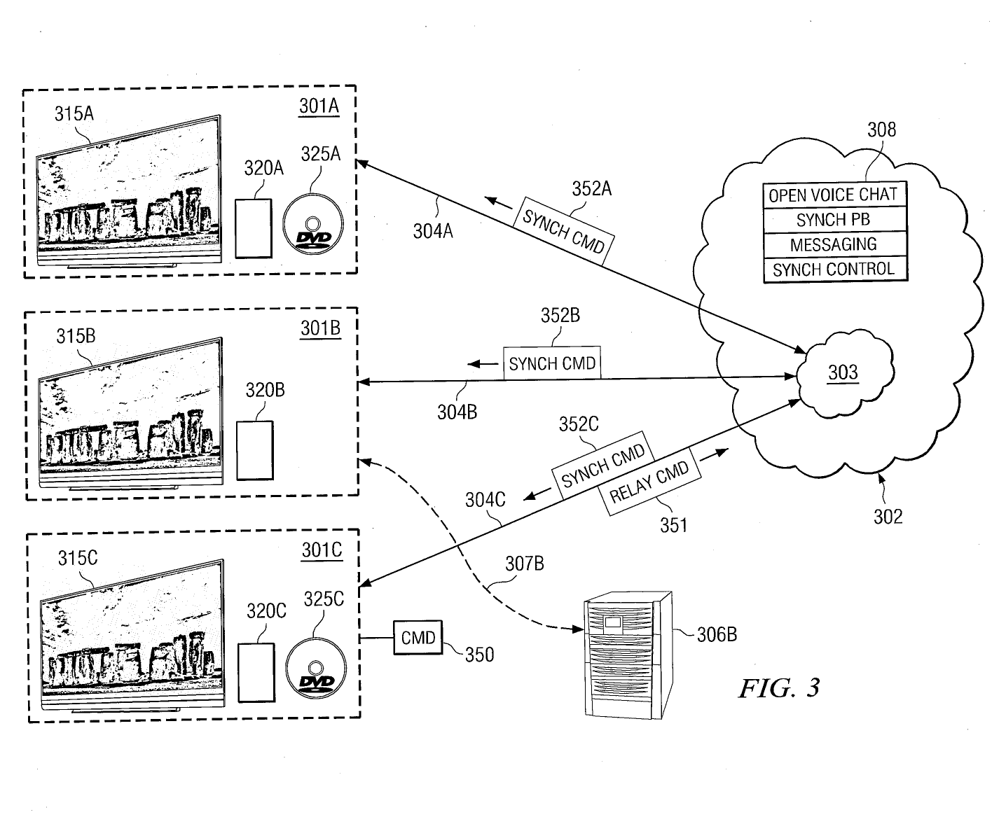

Turning now to FIG. 3, another embodiment of the With-Me platform is illustrated. As noted above, although parts and components on FIG. 3 are assigned numbers in the 300 series, common parts or components illustrated in the various embodiments of FIGS. 1, 2, 3 and 4 are assigned corresponding numbers within each FIGURE's series of numbers. The embodiment of FIG. 3 is similar to the embodiment of FIGS. 1 and 2, except that User Locations 301A and 301C on FIG. 3 are sourcing the common coordinated content via playback of an offline DVD (each of User Locations 301A and 301C possessing, at the User Location, their own legal copies of the DVD 325A and 325C), while User Location 301B on FIG. 3 is sourcing its content via its own authorized subscription to a digital streaming service 306B (such as an offering by Hulu®). In this way, FIG. 3 illustrates further that the With-Me platform is content-provider-agnostic.

The operation of the With-Me platform in FIG. 3 is similar to the With-Me operation described above with respect to FIGS. 1 and 2. User Locations 301A, 301B and 301C are again physically and/or geographically located apart from one another, but are connected via the With-Me platform (illustrated on FIG. 3 as network/cloud 302). As above in FIGS. 1 and 2, one User Location on FIG. 3 (and it may be any User Location at any moment in time) instructs the With-Me platform to begin synchronized delivery of the content to each User Location (either from the beginning of the content “show” or from a specific point desired by the initiating User Location), regardless of each User Location's source of the common content. Optionally, the With-Me platform may also check the DVD copies at User Locations 301A and 301C to ensure that each DVD is an authorized copy of the original under copyright or other digital media rights laws. Under such option, the With-Me platform may then block participation in the shared media event by any User Location that does not possess an authorized copy of the original.

As described above with reference to FIG. 2, it will be appreciated that all disclosure above associated with FIG. 1 regarding shared control (including playback commands, messaging and User Location interactivity during playback) also applies with equivalent effect to the embodiment of FIG. 3. In the case of the embodiment illustrated on FIG. 3, therefore, once any one of the User Locations 301A, 301B or 301C has issued a command to start playback, With-Me will coordinate synchronized delivery of the content to each User Location. User Locations will then have shared control over the playback (and other User Location interactivity) via relaying/echo back of commands (see items 350, 351 and 352A/B/C on FIG. 3).

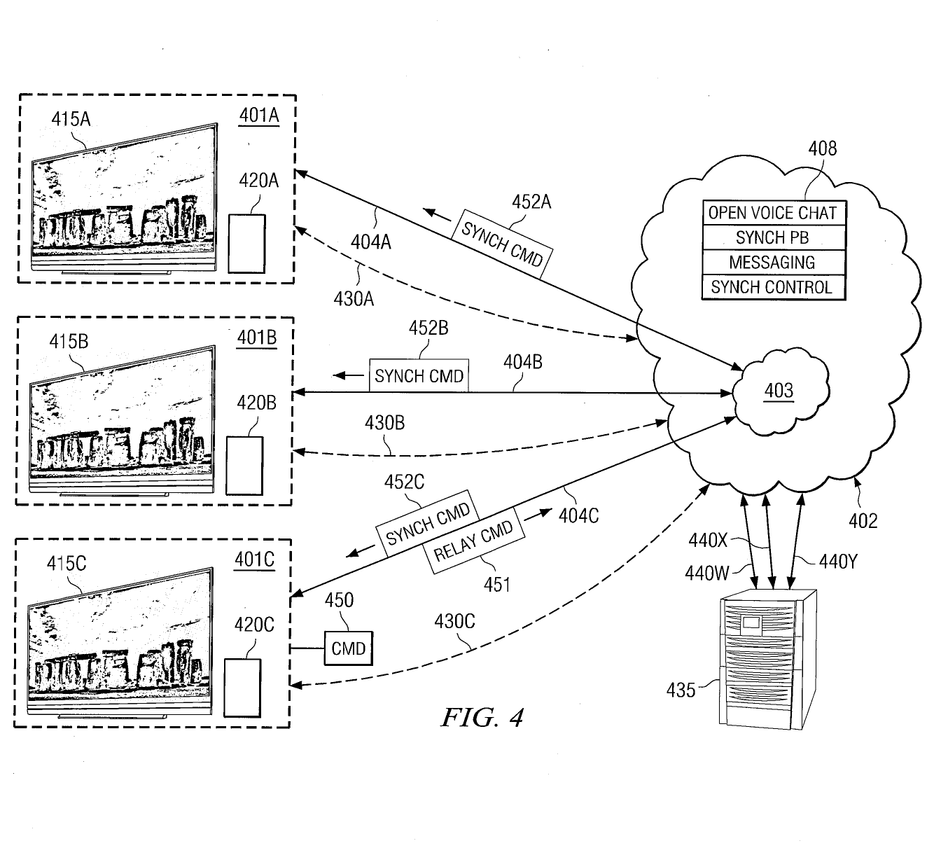

FIG. 4 illustrates another embodiment of the With-Me platform. As noted above, although parts and components on FIG. 4 are assigned numbers in the 400 series, common parts or components illustrated in the various embodiments of FIGS. 1, 2, 3 and 4 are assigned corresponding numbers within each FIGURE's series of numbers. The With-Me embodiment illustrated in FIG. 4 is similar to the embodiments illustrated in FIGS. 1, 2 and 3, except that in FIG. 4, the With-Me platform delivers the shared content as well as separately coordinating the control of the coordinated content. Operation of the With-Me platform on FIG. 4 (including initialization of the group event, cuing, coordination, synchronized playback, and playback control among User Locations 401A, 401B and 401C) is the generally the same with respect to FIG. 4 as is illustrated and described above with reference to the embodiments of FIGS. 1, 2 and 3. In FIG. 4, however, and in contrast to the embodiments illustrated in FIGS. 1, 2, and 3, User Locations 401A, 401B and 401C need not have their own separate subscriptions to and/or and accounts with third party digital streaming content service providers, or have their own legal copies of offline content (such as a DVD). Instead, as illustrated in the embodiment of FIG. 4, the With-Me platform may act as a unified reseller/distributor of streaming digital content for third parties to some or all in the group of User Locations 401A, 401B or 401C. When With-Me acts as a unified reseller/distributor according to FIG. 4, a User Location's access to the content via the With-Me platform may be, for example, by separate individual subscription.

It is nonetheless important to re-emphasize that With-Me is content-provider-agnostic, even when the With-Me platform itself is the vehicle via which a User Location gains its own authorized access to a third party content service provider. Although FIG. 4 illustrates all three User Locations 401A, 401B and 401C obtaining the shared content, as each User Location may be individually authorized, from digital streaming service provider 435 via the With-Me platform (see pathways 430A/B/C and 440W/X/Y on FIG. 4), it will be appreciated that in other embodiments, any of User Locations 401A, 401B or 401C may alternatively obtain the shared content directly (that is, independently of the With-Me platform), such as illustrated and described above with reference to FIGS. 1, 2 and 3.

The aspect of the With-Me platform illustrated in the embodiment of FIG. 4 is best further described by further example. Say, for instance, on FIG. 4, User Locations 404A, 404B and 404C are With-Me platform subscribers who would like to watch a particular movie together. None of User Locations 404A, 404B or 404C, however have authorized subscriptions to a digital streaming service provider that offers this movie, and none of them have a legal copy of the movie on offline media (such as a DVD). As shown on FIG. 4, With-Me may have agreements with Sony®, or NetFlix®, or other digital streaming movie content providers to provide layered content on an account or subscription basis. User Locations 401A/B/C may therefore source the movie via their own independent With-Me platform subscriptions. Before coordinating the common content event and synchronously delivering the movie to the group, the With-Me platform will first require that User Locations 401A, 401B and 401C each provide their won valid With-Me platform credentials to receive the chosen movie via the With-Me platform. In this way, the With-Me platform may becomes a reseller and/or a distributor of third party content, and thus potentially generate a revenue stream by reselling and/or distributing third party content. As noted above, this resale/distribution function would be in addition to the group coordination, synchronous playback and control functions described above with reference to FIGS. 1, 2 and 3.

It will be appreciated that although the embodiment of FIG. 4 illustrates, by example, a group event in which all of User Locations 401A, 401B and 401C gain access to the shared content via the With-Me platform, the inventive technology disclosed in this application is not limited in this regard. Other embodiments (not illustrated} are possible, in which only some of the User Locations in the group event source the shared content via the With-Me platform per the embodiment of FIG. 4. Other User Locations in the group may source the shared content directly, (that is, independently of the With-Me platform), such as illustrated and described above with reference to FIGS. 1, 2 and 3.

It will be further appreciated that all disclosure above associated with FIG. 1 regarding shared control (including playback commands, messaging and User Location interactivity during playback) also applies with equivalent effect to the embodiment of FIG. 4. In the case of the embodiment illustrated on FIG. 4, therefore, once any one of the User Locations 401A, 401B or 401C has issued a command to start playback, With-Me will coordinate synchronized delivery of the content to each User Location. User Locations will then have shared control over the playback (and other User Location interactivity) via relaying/echo back of commands (see items 450, 451 and 452A/B/C on FIG. 3).

It will be yet further appreciated that the embodiment of FIG. 4 is not limited to digital streaming movie content delivered by the With-Me platform via agreements with third party providers. Consistent with FIG. 4, the With-Me platform may, in other embodiments, deliver to User Locations 401A/B/C any media content to which the With-Me platform has access, separate and apart from the With-Me platform's group coordination, synchronized playback and playback control functions over the delivered media content.

Although not illustrated, the With-Me platform has additional optional features.

Talk-with-Me:

To emphasize disclosure above, User Locations can communicate during media playback via text-chat or video/audio chat, allowing them to comment and converse on what they are watching. This is done by adding another stream for the chatting capability. Text chat can also be implemented utilizing the same control channel used for media control.

Buy-with-Me:

Social interaction also offers the possibility to suggest purchase options between participating User Locations, or to send a gift from one User Location to another. The With-me platform can act as a relay for such purchases or gifts. This leads to the next feature

Virtual Date: The With-Me platform may enable a “virtual date” where, for example, two people at separate User Locations have a “dinner and a movie” experience while physically in different location, while, “in case of early dating” preserving the privacy of their home addresses etc.

Buy-With-Me and Virtual Date allow for a complete experience including purchase/e-commerce included options that (for example) allow one party to send flowers (or a pizza) to a second party during the “meeting” while preserving each other's privacy (address, phone number, etc).

Taking privacy concerns one stage further, the With-Me platform may charge the ordering person's account, then proxy the order to the merchant using the With-Me platform's information as the sender/payer. This would help ensure a totally private purchase experience.

The above privacy features can be extended further by being coupled with virtual communications services to provide a complete solution for dating privacy. Similar to private ordering, anonymous communications (like: postal greeting cards, postal mail, SMS, telephone numbers) can be proxied through the With-Me platform.

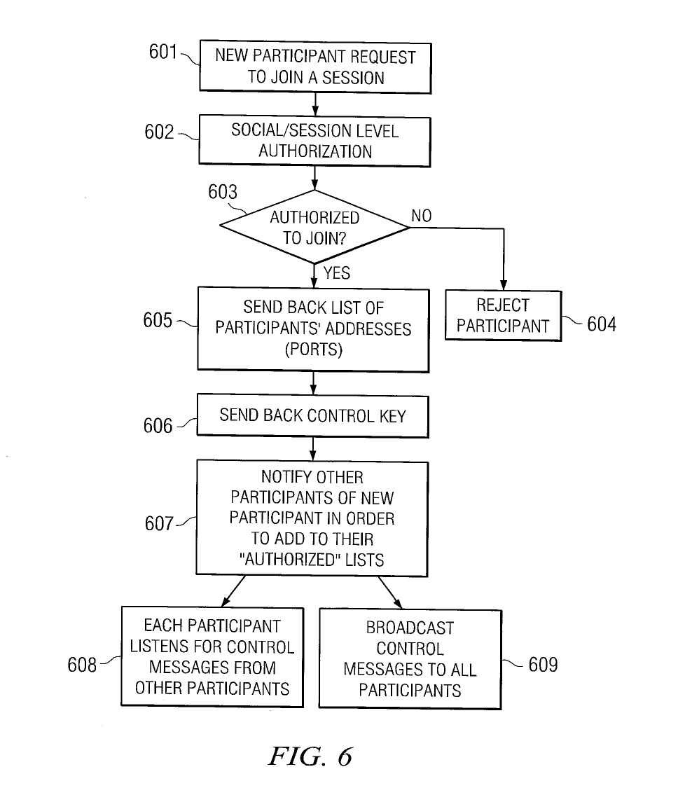

FIG. 6 is a flow chart of an aspect of the “media control command” function of the With-Me platform. Re-emphasizing earlier disclosure, the media control command structure is separate in the With-Me platform from other With-Me structure that synchronizes delivery of the media content itself. In the embodiment of FIG. 6, a new participant requests to join a session, such as a group event (box 601). With reference back to FIGS. 1 to 4, such a “new participant” would correspond on FIGS. 1 to 4 to a new User Location 101A/B/C as shown, for example, on FIG. 1. The new participant attempts login to the With-Me platform, and the With-Me platform either accepts or rejects the new participant based on the credentials provided (boxes 602, 603 and 604 on FIG. 6). If the new participant's With-Me login credentials are accepted, the With-Me platform then sends several pieces of information back to the new participant's local With-Me interface (such as media playback devices 120A/B/C on FIG. 1) in order to add and include the new participant in shared media control by all participants in the coordinated group event. Referring momentarily to the embodiment illustrated on FIG. 8, these pieces of information include a list of the other participants' addresses (ports) on the With-Me platform (box 605 on FIG. 6), and a control key (box 606). In contrast, referring now to the embodiment illustrated on FIG. 7, these pieces of information are sent to the central message control (item 710 on FIG. 7). The With-Me platform also notifies the other participants of the new participant's presence in the group event (box 607). The new participant is now able to participate in shared media control over the group event with all other participants. As shown on FIG. 6, the shared media control includes each participant listening for control messages (or commands) from other participants as the group event progresses (box 608), and the With-Me platform echo-back-broadcasting control messages (commands) to all participants as any participant issues such a message/command and relays it to the With-Me platform (box 609). It will be appreciated that the function described on box 609 of FIG. 6 relates to the disclosure above to items 150, 151 and 152 A/B/C on FIG. 1.

FIGS. 7 and 8 illustrate alternative embodiments of the separation by the With-Me platform of session control over the media in a coordinated group event from message control (or command control) over the media: “Session control” on FIGS. 7 and 8 refers to the With-Me platform setting up the coordinated group event, including gate-keeping who may or may not join the group event (e.g. validating login credentials of new participants as they request to join), notifying other existing participants of accredited new participants' arrival in the group event, and enabling accredited new participants to participate fully in the group event (such as shared control over the media). “Message control” on FIGS. 7 and 8 refers to the With-Me platform controlling, executing, relaying and echoing back messages and commands issued by the participants as the coordinated group event progresses. Such messages and commands have been described in detail in earlier disclosure, and include playback commands (“stop, pause, rewind, etc.), text or voice messages between participants, like/dislike flags, etc.

It will be appreciated that in any given coordinated group event, the amount of digital traffic created by session control, as described above, is likely to be much less than the digital traffic created by message control, as described above. Session control involves the execution and enablement of several one-time tasks such as validating a requesting participant's credentials and notifying other participants of a new participant's arrival. By contrast, message control involves a potentially continuous processing of control messages and commands as participants control the playback and otherwise interact during a group event. Thus, processing efficiencies are available when the With-Me platform separates session control from message control, as shown by the embodiments illustrated on FIGS. 7 and 8.

FIG. 7 illustrates three clients participating in a coordinated group event (705A, 705B and 705C) each receiving a synchronized delivery of common digital streaming media (702A, 702B and 702C) from its own respective media server 701A, 701B and 701C. In this respect, FIG. 7 is equivalent and analogous to the exemplary With-Me embodiment illustrated on FIG. 2 and described in detail above, where clients 705A/B/C on FIG. 7 correspond to User Locations 201A/B/C on FIG. 2, media servers 701A/B/C on FIG. 7 correspond to digital streaming service providers 206A/B/C on FIG. 2, and pathways 702A/B/C on FIG. 7 correspond to pathways 207A/B/C on FIG. 2. All disclosure above, including with reference to FIGS. 1 to 4, regarding the With-Me platform being content-provider-agnostic, also applies with reference to FIG. 7. Although FIG. 7 illustrates clients 705A/B/C. as sourcing their respective synchronized content from media servers, the inventive technology disclosed in this application is not limited in this regard. In other embodiments, any client 705A/B/C may source its content from any legal source, streaming or offline, to which the client has access (including, per FIG. 4 and associated disclosure, the With-Me platform itself when With-Me is configured to provide such content via agreements with third party providers).

FIG. 7 illustrates the separation of session control from media control in a centralized message control environment. The With-Me platform is represented on FIG. 7 by network/cloud 707. Session control 711 and message control 712 are deployed on FIG. 7 functionally both within network/cloud 707, although each of session control 711 and message control 712 is its own separate function and architecture. Session control 711 interacts with the local With-Me interfaces at clients 705A/B/C via respective pathways 709A, 709B and 709C. Message control, in contrast, interacts with the local With-Me interfaces at clients 705A/B/C via respective pathways 706A, 706B and 706C.

Although not illustrated as such, it will be appreciated that other embodiments of FIG. 7 might deploy session control 711 in a completely different network or cloud from message control 710, or on a physically separate server, or at a completely different network address, than might be suggested by FIG. 7 by having both items depicted in the same network/cloud 707. The inventive technology disclosed in this application is not limited by the manner in which session control or message control might be separate.

FIG. 8 depicts an alternative embodiment of the separation of session control and message control, in which message control is illustrated in a distributed environment. FIG. 8 is functionally the same as FIG. 7 as regards to clients 810A/B/C, media server 801A/B/C, pathways 802A/B/C, session control 815 and pathways 817A/B/C, and all disclosure above referencing FIG. 7's corresponding features applies equivalently to FIG. 8 and these common features as depicted on FIG. 8.

On FIG. 8, however, and in contrast to FIG. 7, message control 810A/B/C is deployed distributively in each client's local With-Me interface rather than in network/cloud 812. In the embodiment of FIG. 8, With-Me enables message control at the local level, enabling clients to issue commands, share playback control and otherwise interact during the group event. Pathways 811A, 811B and 811C illustrate this client interactivity on FIG. 8.

It will be therefore appreciated that a feature of preferred embodiments of the With-Me platform is to optimize processing by separating session control from message control. This feature, and its associated processing advantages, may be enabled in numerous alternative embodiments, including those described above and illustrated on FIGS. 7 and 8.

One additional item of note on the embodiment illustrated on FIG. 8 is that when session control 815 identifies a new client wishing to log in to the With-Me platform, session control 815 optimally needs to process a join/acknowledge message in order to properly integrate the new client into the group event. Since message control 810A/B/C is distributed among clients, it is more cumbersome for session control to receive and process such a message. This may be overcome by session control accepting the first acknowledgement message received from message control, and then ignoring any subsequent ones.

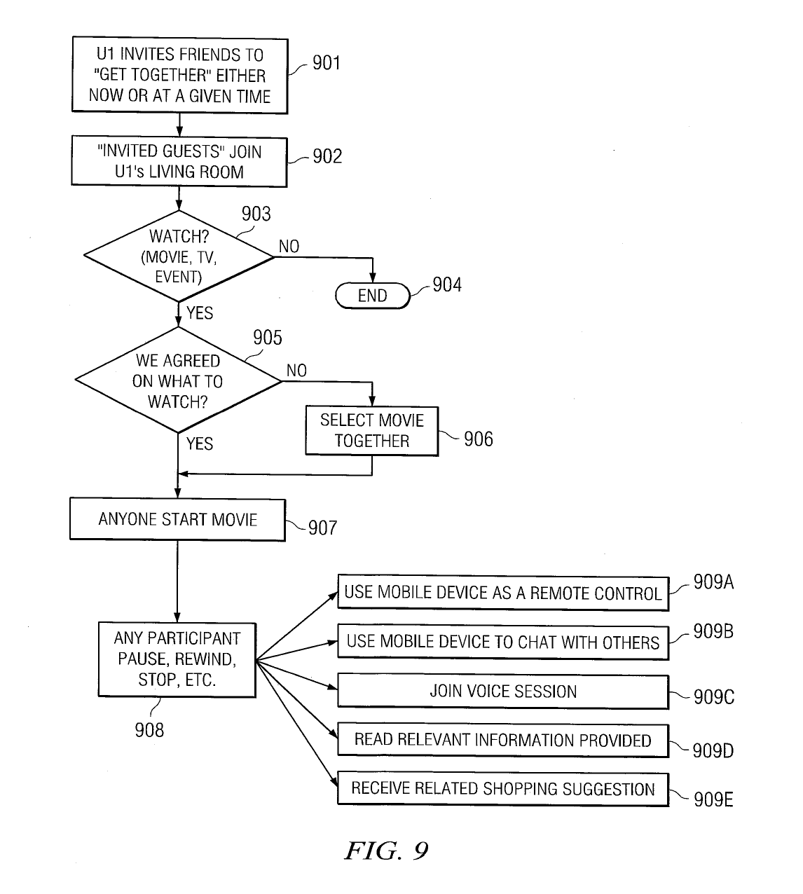

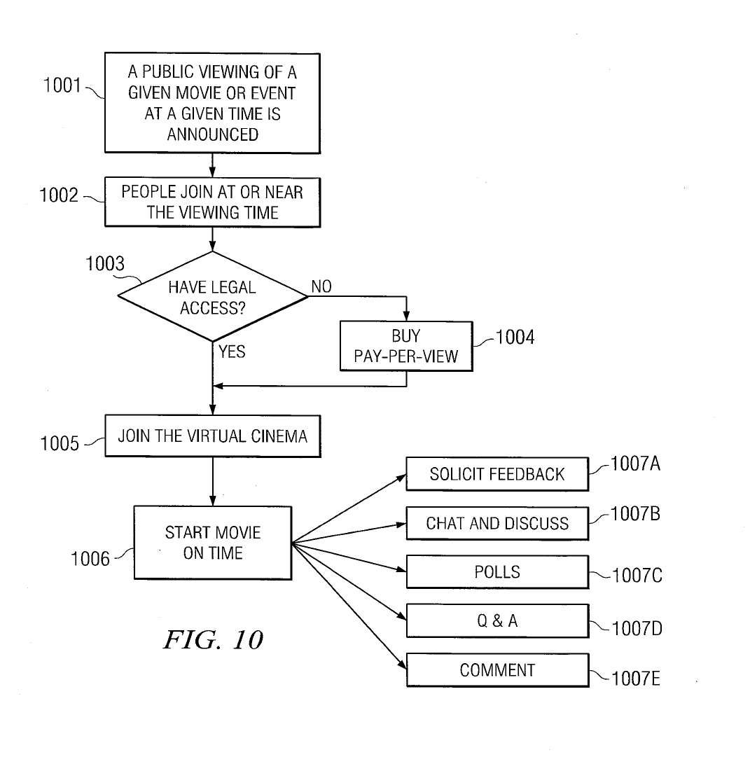

FIGS. 9 and 10 illustrate alternative embodiments of deployment environments of the With-Me platform. FIG. 9 is a flow chart of a “virtual living room” style of implementation of the inventive With-Me technology disclosed in this application. FIG. 10, by contrast, is a flow chart of a “virtual cinema” style of implementation.

Referring first to FIG. 9, boxes 901 through 908 generally illustrate aspects of an example of a With-Me implementation that has been discussed extensively earlier in this disclosure. See generally the corresponding disclosure above referring to FIG. 1, which applies in equivalent fashion to FIG. 9. In boxes 901 to 906 on FIG. 9, individuals gather at a User Location (per FIG. 1) such as a person's living room, and decide with individuals at other User Locations on a common digital media playback (or “rendering”) to experience “together” (such as watching a movie “together”). According to the With-Me platform, any User Location may start the playback of the movie at any time (box 907 on FIG. 9). Once started, any User Location may issue a command to With-Me to pause, rewind or stop the movie, for example, in response to which With-Me will pause, rewind, stop, etc. the movie at all User Locations (box 908 on FIG. 9). Again, see generally the corresponding disclosure above associated with FIG. 1, which covers these functions in greater detail.

Boxes 909A through 909E on FIG. 9 illustrate examples of commands, messages and other interactivity that may be implemented as With-Me enables shared control of the playback among all User Locations. Box 909C, joining a voice session among User Locations, has been discussed in detail above with reference to FIG. 1.

Boxes 909A and 909B on FIG. 9 illustrate that individuals at User Locations may use their mobile devices (e.g. smart phones, tablet computers) to have additional shared interactivity with other User Locations during playback. The mobile device may connect to the With-Me platform via any convenient means, such as Wi-Fi or 3G. Once connected, software on the mobile device (e.g. an “app” or web page/web portal) may permit the mobile device to be used, for example, as a remote control (box 909A) from which media playback control commands may be issued (e.g. stop, pause, rewind, etc.) Alternatively, per box 909B on FIG. 9, the mobile device may be used as an apparatus with which to interact with other User Locations (e.g. voice chat, text, IM, etc.)

Boxes 909D and 909E on FIG. 9 illustrate that the With-Me platform may also use its message control functionality to deliver relevant information to all (or selected) User Locations during playback of the content. Per box 909D on FIG. 9, the With-Me platform might, purely by way of example, deliver “pop-up” information regarding the playback as it happens, such as background information or trivia on scenes or characters in a movie as the movie progresses. Alternatively the delivered information might be news or weather alerts during the playback. The scope for types of information delivered is not limited. Box 909E on FIG. 9 further illustrates a “shopping suggestions” as a particular type of information that the With-Me platform might deliver to all (or selected) User Locations. For example, User Locations may be watching a movie “together”, and at a certain point the plot might show a character wearing a desirable jacket. The With-Me platform, according to box 909E on FIG. 9, would make shopping suggestions to all (or selected) User Locations identifying the jacket and locations (online or in a store) where that jacket might be purchased, and for what price. The With-Me platform may also, for example, suggest other purchases like buying this movie's DVD, or related movies to watch/buy, or merchandise related to this movie's topic/plot, or travel destinations related to the movie.

FIG. 10 illustrates, in contrast to FIG. 9, an exemplary implementation style of the With-Me platform that may be characterized as a “Virtual Cinema”. For purposes of comparison with FIG. 9, the common shared content in the example illustrated on FIG. 10 is also a movie. In FIG. 10, however, instead of individuals at User Locations gathering to watch the movie at a time agreed upon among themselves, the movie has been pre-designated to begin at a specific, and advantageously pre-announced time. In this regard, therefore, the embodiment illustrated on FIG. 10 resembles a showing of the movie at a cinema. Referring to FIG. 10, and specifically boxes 1001 through 1005 on FIG. 10, User Locations “gather” by logging in to the With-Me platform at or just before the pre-designated “show time” and may either access the movie via their own legal sources (e.g. subscriptions to digital streaming service providers, possession of a legal offline copy such as a DVD, etc.), or may alternatively obtain access via a pay-per-view service either directly, or via the With-Me platform itself (see disclosure above associated with FIG. 4 for more on this feature). In contrast to box 907 on FIG. 9, however, where any User Location may start the FIG. 9 movie for all User Locations at any time, With-Me starts the movie on FIG. 10 for all User Locations at the pre-designated time (box 1006 on FIG. 10).

Once the movie has started, With-Me may then use its message control function to coordinate various types of interactivity between User Locations as synchronized playback continues. Boxes 1007A through 1007E illustrate examples of types of such interactivity. It will be appreciated that, by contrast to boxes 909A through 909E on FIG. 9 and associated disclosure, the types of commands, messaging and interactivity that might be appropriate under the FIG. 10 “virtual cinema” implementation are somewhat different from those perhaps more appropriate under the FIG. 9 “virtual living room” implementation, even though With-Me is enabling this differing activity in both FIGS. 9 and 10 via the same message control function. In the FIG. 10 “virtual cinema” implementation, the With-Me message control function allows for group data-gathering such as focus groups, test marketing, etc. Referring to FIG. 10, With-Me may, purely by way of example, solicit feedback on the movie, or its characters, from all or selected User Locations (box 1007A), or promote chat or discussion regarding the movie (box 1007B). With-Me may further conduct polls among User Locations (box 1007C), conduct specific question and answer sessions (box 1007D), or solicit comments on particular subject matter related to the movie as it plays (box 1007E). The scope for types of User Location interactivity promoted or data potentially to be gathered is not limited.

It will be further appreciated with reference to FIG. 10 that the With-Me message control function may allow for one (or more) User Location(s) to be the “gatherer” of focus test or other data from other User Locations, or the promoter of organized discussion, comments, feedback or questions/answers. In other embodiments, some or all of this User Location interactivity may be promoted automatically by With-Me as the movie runs, according to pre-determined scripts.

Although the inventive technology disclosed in this application, and the advantages thereof, have been described in detail in the foregoing paragraphs and with reference to FIGS. 1 through 10, it should be understood that various changes, substitutions and alternations can be made herein without departing from the spirit and scope of such inventive technology as defined by the appended claims.

I claim:

1. A method for enabling a coordinated event among a plurality of user locations, each user location located geographically separate from all other user locations, the coordinated event comprising a substantially synchronous rendering of a predetermined and common digital media stream at each user location, the method comprising the steps of:
(a) requiring each user location to identify its own personal independent source of the common digital media stream;
(b) causing each user location's personal independent source of the common digital media stream to render the common digital media stream at the corresponding user location; and
(c) synchronizing said renderings of the common digital media stream in step (b) at each user location regardless of and agnostic to each user location's personal independent source thereof.

2. The method of claim 1, further including the step of:
(d) providing user location intermessaging interactivity as a network-topologically discrete function separate from the synchronizing in step (c), wherein the user location intermessaging interactivity includes playback control over said renderings of the common digital media stream in step (b) to each user location on a fully shared basis among user locations.

3. The method of claim 2, in which the user location intermessaging interactivity in step (d) is further separated into session control and message control, and wherein session control and message control are provided as two network-topologically discrete functions.

4. The method of claim 1, in which the synchronizing in step (c) is agnostic to whether said renderings of the common digital media stream in step (b) among user locations are out of synchronicity within a predetermined amount.

5. The method of claim 4, in which the predetermined amount is about 2 seconds.

6. The method of claim 1, in which: (1) the plurality of user locations is two user locations, and (2) the coordinated group event is for the user locations to eat an agreed meal at the same time and to watch an agreed movie at the same time.

7. The method of claim 2, in which the user location intermessaging interactivity further includes suggestion of purchase options to ones of the user locations.

8. The method of claim 7, in which ones of the user locations make purchases responsive to said purchase option suggestions, and in which financial information enabling said purchases sent by user locations via user location intermessaging interactivity is kept private via corresponding proxy purchases.

9. The method of claim 2, in which the user location intermessaging interactivity in step (d) is enabled by the substeps of:
(d1) any user location generating a message;
(d2) relaying the message to a message control;
(d3) responsive to substep (d2), echo-back re-broadcasting the message from the message control to all user locations; and
(d4) responsive to substep (d3), acting substantially simultaneously at all user locations on information contained in the message.

10. The method of claim 1, further including the step of providing user location intermessaging interactivity as a network-topologically discrete function separate from the synchronizing in step (c), and wherein: (1) the synchronizing in step (c) begins at a pre-designated time, and (2) the user location intermessaging interactivity includes at least one interactivity selected from group consisting of:
(A) soliciting feedback from user locations regarding the coordinated event;
(B) exchanging information between user locations discussing the coordinated event;
(C) polling user locations regarding the coordinated event;
(D) organizing question and answer sessions with ones of the user locations regarding the coordinated event; and
(E) organizing comments from ones of the user locations regarding the coordinated event.

11. The method of claim 2, in which the user location intermessaging interactivity includes at least one interactivity selected from group consisting of:
(A) using a mobile device as a remote control over playback control over said renderings of the common digital media stream in step (b);
(B) using a mobile device to enable the user location intermessaging interactivity;
(C) exchanging information between user locations discussing the coordinated event;
(D) receiving relevant information regarding the coordinated event; and
(E) receiving shopping suggestions ancillary to the coordinated event.

12. The method of claim 1, in which at least one user location's personal independent source of the common digital media stream is selected from the group consisting of:
(A) a digital streaming service provider;
(B) a physical storage medium; and
(C) a digital file storage device other than a physical storage medium.

13. A method for enabling a coordinated event among a plurality of user locations, each user location located geographically separate from all other user locations, the coordinated event comprising a substantially synchronous rendering of a predetermined and common digital media stream at each user location, the method comprising the steps of:
(a) synchronously rendering the common digital media stream at each user location; and
(b) providing user location intermessaging interactivity as a network-topologically discrete function separate from the synchronizing in step (a), wherein the user location intermessaging interactivity includes playback control over said renderings of the common digital media stream in step (a) to each user location on a fully shared basis among user locations.

14. The method of claim 13, in which the user location intermessaging interactivity in step (b) is further separated into session control and message control, and wherein session control and message control are provided as two network-topologically discrete functions.

15. A method for enabling a coordinated event among a plurality of user locations, each user location located geographically separate from all other user locations, the coordinated event comprising a substantially synchronous rendering of a predetermined and common digital media stream at each user location, the method comprising the steps of:
(a) synchronously rendering the common digital media stream at each user location; and
(b) correcting asynchronicities in said synchronous renderings of the common digital media stream in step (a) responsive only to a condition selected from the group consisting of:
(1) when said asynchronicities exceed a predetermined amount among user locations;
(2) when any user location issues a command to resynchronize; and
(3) when any user location issues a playback control command over said synchronous renderings of the common digital media stream in step (a).

16. The method of claim 15, in which the predetermined amount in step (b) is about 2 seconds.

17. The method of claim 15, in which correcting of asynchronicities in step (b) further includes (1) sending a media time code and command to all user locations to resynchronize to a playback position in the rendering of the common digital media stream that corresponds to the media time code, and (2) not waiting for a synchronization message in response thereto from any of the user locations.
